(19) United States
(12) Patent Application Publication
(10) Pub. No.: US 2005/0076333 A1
(43) Pub. Date: Apr. 7, 2005

(54) Method of installing a software release

(75) Inventors: Jeff Leclair, Windsor (CA); Craig Parker, Kanata (CA); Todd Winn, Stittsville (CA); Mark Kettle, Carp (CA)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Nortel Networks Limited, St. Laurent (CA)

(21) Appl. No.: 10/925,620

(22) Filed: Aug. 25, 2004

Related U.S. Application Data
(60) Provisional application No. 60/509,337, filed on Oct. 7, 2003.
(60) Provisional application No. 60/510,631, filed on Oct. 10, 2003.

(51) Int. Cl. G06F 9/445

(52) U.S. Cl. 717/176

(57) ABSTRACT

A method of installing a software release on a network element is described. The method includes providing at a source external to the network element a software release for delivery to a file system of the network element, and receiving from the source external to the network element the complete software release before installing the software release on the network element. The software release includes files for providing the operational characteristics of the network element.

### RELATED APPLICATION

This application claims the benefit of U.S. Provisional Patent Application No. 60/509,337 filed on Oct. 7, 2003, and U.S. Provisional Patent Application No. 60/510,631 filed on Oct. 10, 2003, the entire contents of both provisional applications are incorporated herein by reference.

### FIELD OF THE INVENTION

The invention relates to a method of installing software. More specifically, the invention relates to a method of installing software on a network element deployed in a telecommunications network.

### BACKGROUND OF THE INVENTION

Users currently upgrade or install software operating on the cards of their network elements by transmitting the new version of software piecemeal over the network to the network element. Files needed for completing the upgrade traverse the network at various stages in the upgrade process, often on an as-needed basis. This method of upgrading, however, is exposed to a myriad of potential problems, such as transmission errors, fiber breaks, incomplete transmissions, and interrupted network connections, any of which could cause the upgrade to fail. Any such failure interrupts the complete delivery of the necessary files, leaving the network element in a worse state than before the upgrade began. For instance, each card maintains a working copy and a redundant copy of its software in two banks of memory. The redundant copy serves as a failsafe in the event the working copy becomes corrupted. The upgrade software is typically stored in the memory bank with the redundant copy, overwriting the redundant copy. Incomplete delivery of the necessary files causes the card to operate without the protection of this failsafe until the user can successfully complete the upgrade after the problem that caused the failure is resolved.

### SUMMARY OF THE INVENTION

In one aspect, the invention features a method of installing a software release on a network element. The method includes providing at a source external to the network element a software release for delivery to a file system of the network element, and receiving from the source external to the network element the complete software release before installing the software release on the network element.

In another aspect, the invention features a computer readable medium having instructions for installing software on a network element of an optical communications system. The network element has a plurality of communications cards and a file system. The computer readable medium includes instructions to cause the network element to communicate with a source external to the network element to receive from the external source the complete software release before beginning the installation the software release on the network element. The software release includes a plurality of files that provide the operational characteristics of the communications cards of the network element.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a computer system.

FIG. 2 is a representation of a network environment in which an embodiment of the invention may be practiced.

FIG. 3 is a block diagram of a network element in which principles of the invention may be practiced.

FIG. 4 is a block diagram of an embodiment of a shelf processor card of FIG. 3.

FIG. 5 is a block diagram of an embodiment of a tributary card of FIG. 3.

FIG. 6 is a flow chart of an embodiment of a method for installing software according to principles of the invention including an invoke phase and a commit phase.

FIG. 7 is a flow chart of an embodiment of the invoke phase of FIG. 6.

FIG. 8 is a flow chart of an embodiment of the commit phase of FIG. 6.

### DETAILED DESCRIPTION

As general overview, a network element receives a new software release from a remote device in communication with the network element. Instead of piecemeal transmission of the new software release, as is currently done, the entire new software release is transmitted in a single autonomous transaction. After the new software release is received in it's entirety by the network element, the process of installing the new software release begins.

The new software release includes load software for each card of the network element. The new software release includes files that define the operational characteristics of the network element and files for some types of cards that may not be presently installed in the network element. This feature accommodates the possibility that the network element could, at some point in time, have such types of cards installed therein.

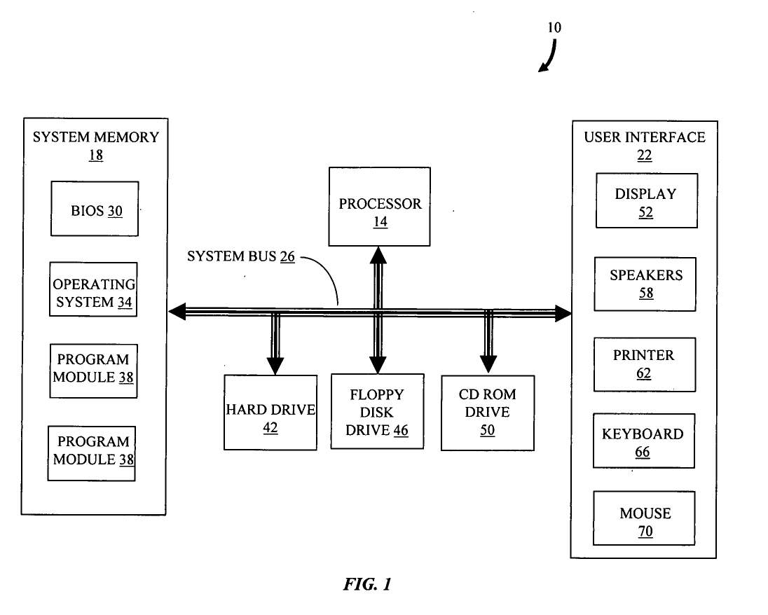

FIG. 1 is a functional block diagram of an embodiment of a computer system 10 that can be used to provide a software release to a network element of a communication system in accordance with principles of the invention. The new software release is copied to the network element prior to installing the new release. The computer system 10 includes a processor 14, a system memory 18 and a user interface 22 coupled to each other over a system bus 26. The system memory 18 includes read-only memory (ROM) and RAM. Basic routines used to transfer information between the components of the computer system 10 at certain times, such as during startup, are included in a basic input/output system (BIOS) 30 in ROM. The BIOS 30 provides an interface between the computer system's operating system 34 (e.g., Windows, Mac OS, Linux) and the specific hardware configuration of the computer system 10, including the processor 14 and the system memory 18. The system memory 18 also includes various program modules 38 such as word processing applications, presentation applications and spreadsheet applications.

The computer system 10 generally includes other components, for example one or more hard disk drives 42, magnetic disk drives 46, optical disk drives 50 and the like. The drives 42, 46, 50 enable read from and write to operations for various forms of computer-readable media and allow for non-volatile storage of computer readable instructions, data structures and other data. The user interface 22 includes a display 54 and other peripheral output devices, such as speakers 58 and a printer 62, connected through various interface modules (not shown) to the system bus 26. Commands and information are entered into the computer system 10 through input devices such as a keyboard 66 and a mouse 70. In one embodiment, the disk drive 46 receives the new software release on a medium such as a compact disk. The network element communicates with the computer system 10 and receives the new software release from the computer system 10.

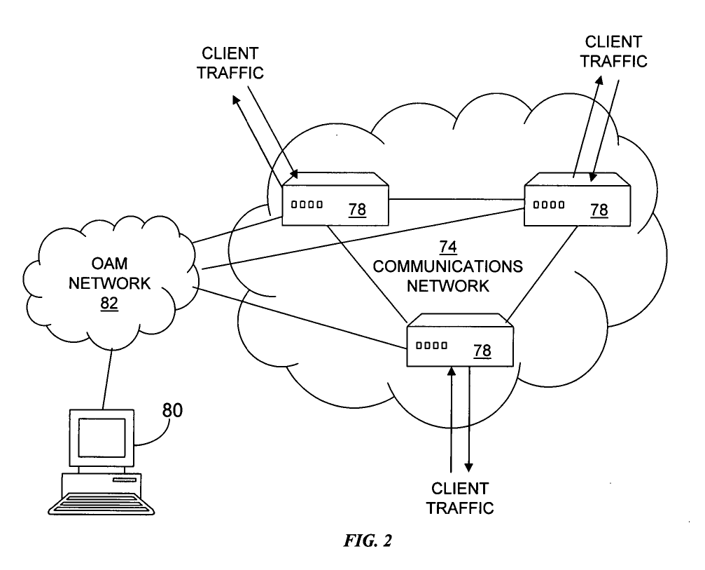

FIG. 2 illustrates a communications network 74 that includes a number of network elements, or communications shelves, 78 (only three shown for clarity), communication paths, and other network components (not shown). As shown, the network elements 78 can communicate with various network devices to receive the new software release. The depicted network elements 78 interface client transport traffic with the communications network 74. Typically, each network element 78 includes a number of shelf cards having various functionalities. Client communications traffic is introduced to the network element 74 through one of the network elements 78, transmitted along one or more communications paths, and delivered to a destination by another of the network element 78.

The network elements 78 and their resources are managed by a remote device 80 (e.g., computer system 10) through an OAM network 82 that is typically independent of the data communications network 74. Management includes issuing commands, such as TL1 (Transaction Language 1) commands, from the remote device 80 to the network elements 78. Each network element 78 includes one or more ports for coupling to the OAM network 82.

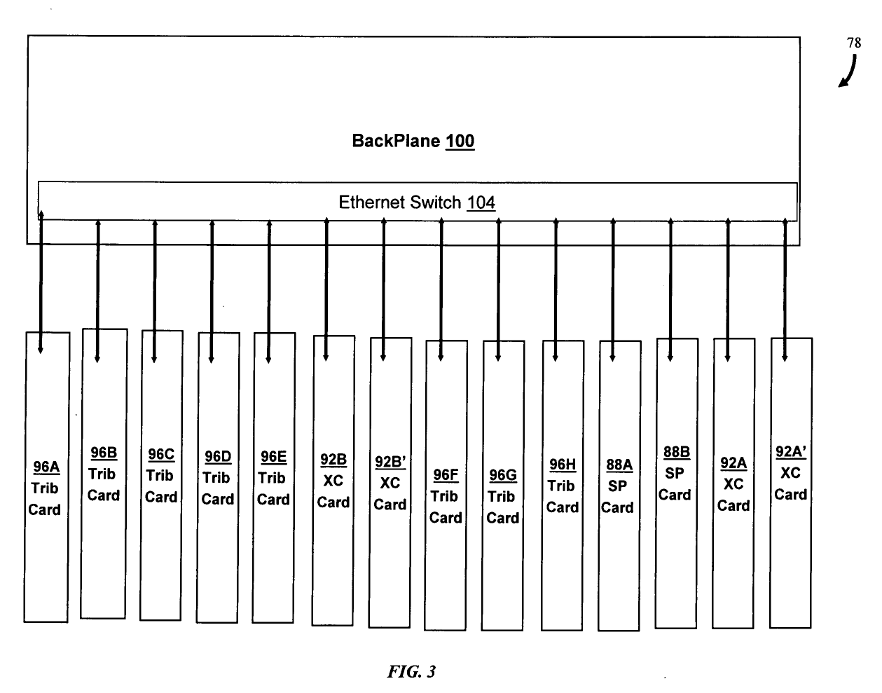

FIG. 3 is a block diagram of an embodiment of the network element 78 of FIG. 2. Each network element 78 includes a master shelf processor card 88 and a redundant shelf processor card 88′ (referred to generally as shelf processor card 88), a pair of cross-connect cards 92A, 92B each having a respective redundant cross-connect card 92A′, 92B′ (referred to generally as cross-connect card 92), a plurality of tributary (or port) cards 96A, 96B, 96C, 96D, 96E, 96F, 96G, and 96H (referred to generally as tributary card 96), and a backplane 100, which includes an Ethernet switch 104 or an abstraction of an Ethernet switch. The shelf processor cards 88, cross-connect cards 92A, 92B, and tributary cards 96 communicate with each other through the backplane 100.

The tributary cards 96 generally receive data signals and produce synchronous transport signals therefrom. Different types of tributary cards 96, for handling different signal formats and different signal rates, can reside within the network element 78. For example, signal formats that can be supported include, but are not limited to, DS1, DS3, E1, E3, Ethernet, OC-3, OC-12, OC-48, and OC-192 (also referred to as high-speed tributary cards). Tributary cards 96 supporting electrical signals (e.g., DS1, DS3) are generally referred to as copper tributary cards; those supporting optical signals, as optical tributary cards. For optical tributary cards, incoming and outgoing optical signals enter and exit the tributary card through ports in the faceplate, as described in more detail below. Embodiments of tributary cards 96 have from one port (e.g., an OC-192 port) to 32 ports. For copper tributary cards, incoming and outgoing electrical signals pass through an input/output interface card (not shown) before passing to or coming from the tributary card 96 by way of the backplane 100.

From an operations perspective, the master shelf processor card 88 is the controller of the network element 78. The master shelf processor card 88, in general, controls the tributary cards 96 and cross-connect cards 92 for provisioning purposes. In one embodiment, the master shelf processor card 88 determines the routes taken by traffic between tributary cards 96. The master shelf processor card 88 also collects alarms from the tributary cards 96, determines which alarms are relevant, and forwards relevant alarms up to the OAM network 82. The master shelf processor card 88 stores the new software release received from the remote element 80 and issues commands to install the new software release in response to user input received by the remote element 80.

During general operation of the network element 78, the tributary card 96A (for example) receives incoming data signals, e.g., through a user-network interface or through a network-network interface. As used herein, an incoming signal is a payload-bearing (i.e., data) signal. Consider, for exemplary purposes only, that the incoming signal is a DS1 signal. The tributary card 96A maps and adapts the DS1 signal into the payload of an electrical STS-1 signal, and sends the STS-1 signal to the cross-connect card 92A over the back plane 100. The cross-connect card 92A switches the data signals to another tributary card 96 in the network element 78. For example, the cross-connect card 92A can forward the STS signal to the tributary card 96D. For illustration purposes only, assume that the tributary card 96D is an optical card which produces an optical signal (e.g., OC-48) representative of at least the STS signal, and places the optical signal onto the communications network. During this operation, the cross-connect cards 92A, 92B provide equipment redundancy. Identical STS signals pass from the tributary card 96A to both cross-connect cards 92A,92B and from both cross-connect cards 92A, 92B to the tributary card 96D. The tributary card 96D selects between the identical STS signal streams.

The cross-connect cards 92A, 92B operate without regard to the type of tributary cards 96 (i.e., DS1, DS3, OC-48) between which the STS signals are being switched. In one embodiment, the backplane 100 operates at an STS-48 rate. The cross-connect cards 92A, 92B can separate the 48 STS-1s received over a link into individual STS-1 units and send different ones of the STS-1 units to different tributary cards 96. In another embodiment, the cross-connect cards 92A, 92B can separate 1344 VT1.5s received over a link into individual VT1.5s, and send different ones to different tributary cards 96.

The backplane 100 includes an abstraction of an Ethernet switch to facilitate communication among the cards of the network element 78. The backplane's 100 abstracted Ethernet switch provides an Ethernet medium for exchanging information between the cards connected to the backplane 100. In addition, the backplane provides a means for the master shelf processor card 88 to distribute the new software release to the other cards 92, 96 of the network element 78.

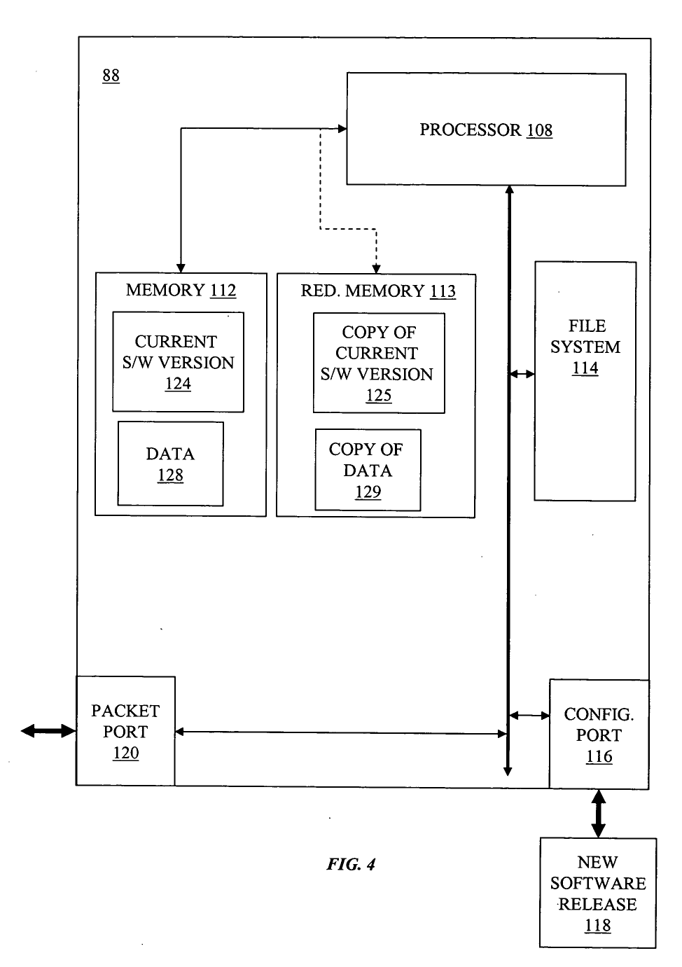

FIG. 4 depicts an embodiment of the master shelf processor card 88 in which principles of the invention may be practiced. The master shelf processor card 88 includes a processor 108, a primary memory element 112, a redundant memory element 113 (both of which are also referred to as memory banks throughout the specification), a file system 114, a configuration port 116, and a packet port 120. The processor 108 communicates with the memory elements 112, redundant memory element 113, and the file system 114.

The remote element 80 (e.g., computer system 10) connects to the configuration port 116 to communicate with the network element 78. In one embodiment, the remote element 80 connects to the configuration port 116 through an RS 232 port. Communication data exchanged between the master shelf processor card 88 and the remote element 80 passes through the configuration port 116. The new software release 118 is delivered to the master shelf processor card 88 from the remote element 80 through the configuration port 116. Communication between the master shelf processor card 88 and backplane 100 occurs through the packet port 120. Network traffic received, processed, and transmitted by the master shelf processor card 88 is also forwarded to the other cards 92, 96 of the network element 78 through the packet port 120.

The primary memory element 112 stores the present software version 124 that is currently running the master shelf processor card 88 and data 128 such as routing tables and databases, which are accessible by the processor 108. In one embodiment, the present software version 124 includes a boot load director, a boot load, and application load code (generally referred to as load software). The redundant memory element 113 contains a copy 125 of the current software version 124 and a copy 129 of the data 128 to provide redundancy within the master shelf processor card 88 should the primary memory element 112 fail or fault. During the installation process, as described in more detail below, both the current software version 124 and the copy 125 of the current software version are replaced with the new software release 118.

The redundant shelf processor card 88′ includes elements and features similar to the master shelf processor card 88. The redundant shelf processor card 88′ provides redundant functionality of the master shelf processor card 88 within the network element 78 in the event the master shelf processor card 88 experiences a fault or failure. The network element 78 transfers processing responsibility to the redundant shelf processor card 88′ if needed to keep the network element 78 operational until the master shelf processor card 88 can be replaced.

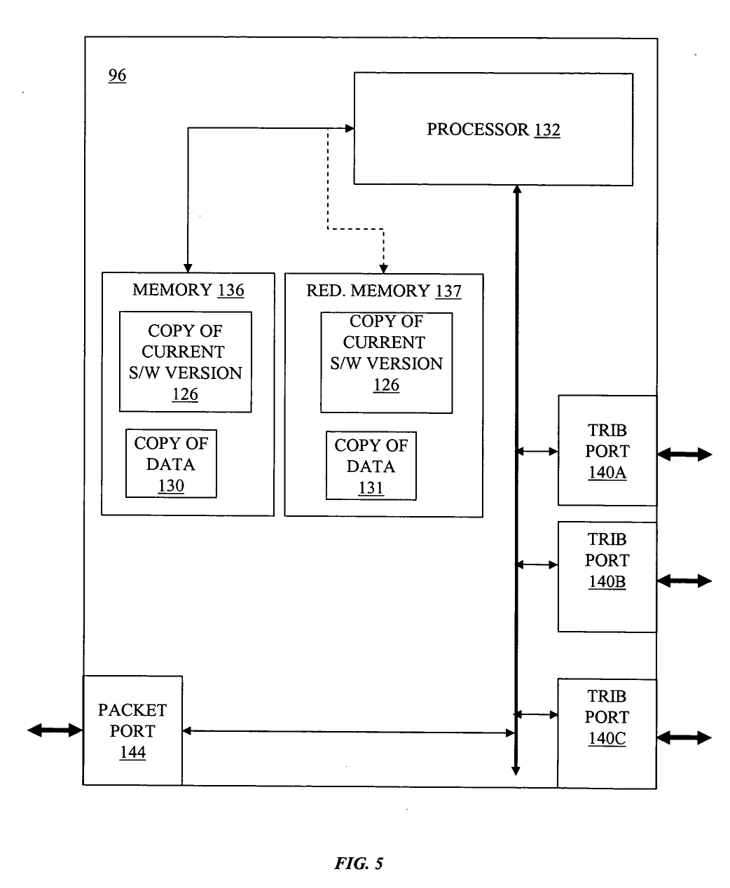

FIG. 5 shows an embodiment of a tributary card 96 of FIG. 3 in which principles of the invention can be practiced. The tributary card 96 includes a processor 132, a primary memory element 136, a redundant memory element 137, a plurality of tributary ports 140A, 140B, 140C (referred to generally as tributary port 140), and a packet port 144. The processor 132 communicates with the primary memory element 136 and the redundant memory element 137. The network element 78 receives network traffic through the tributary ports 140. For example, signal formats that can be supported by the tributary ports 140 include, but are not limited to, DS1, DS3, E1, E3, Ethernet, OC-3, OC-12, OC-48, and OC-192 (also referred to as high-speed tributary cards). The network traffic destined for the master shelf processor card 88, cross-connect card 92A, 92B, and other tributary cards 96 is communicated to the backplane 100 through the packet port 144. The new software release 118 is received from the master shelf processor card 88 through the packet port 144.

The primary memory element 136 stores either a complete copy 126 of the current software version 124 and a copy 130 of the data 128 or only relevant portions of the current software version 124 and data 128. As used herein, relevant portions refer to the files that provide the operational characteristics of the tributary card 96. The redundant memory element 137 contains a copies 127,131 of the contest of the primary memory element 136 (i.e. the current software version 124 and the data 128, respectively) to provide redundancy within the tributary card 96 should the primary memory element 136 fault or fail.

FIG. 6 is a flow chart depicting one embodiment of a method of installing software according to principles of the invention. As a general overview, installing (e.g., upgrading) the new software release 118 on each of the cards 88, 92, 96 in the network element 78 is accomplished in four phases: 1) a delivery phase; 2) a load phase; 3) an invoke phase; and 4) a commit phase. During the delivery phase, the user inserts (STEP 200) a compact disc (CD) or other medium containing the software release into the remote element 80 and connects to the network element 78 through the configuration port 116 or over the network 74. After a connection is established, the user activates a graphical user interface button that causes the transfer (STEP 210) of the entire new software release 118 contained on the CD to the master shelf processor card 88. In the event the entire new software release 118 is not delivered to the file system 114 of the network element 78, the new software release 118 can not be installed. The network element 78 continues to operate using the current software version 124.

The new software release 118 is stored in the file system 114 of the master shelf processor card 88. After the delivery phase, the network element 78 has the files necessary for accomplishing the upgrade or new installation stored in the file system 114 of the network element 78—no additional files need to be later transmitted over the connection from the remote element 80 to the network element 78. Further, upon completion of the delivery phase, none of the cards, including the master shelf processor card 88, has the new software release 118 stored in primary memory element or redundant memory element.

After the new software release 118 is delivered to the file system 114 of the network element 78, the user, through the graphical user interface displayed on the remote element 80, causes the network element 78 to enter (STEP 220) the load phase. During the load phase, the master shelf processor card 88 transfers the new software release 118 from the file system 114 of the network element 78 to the redundant memory element 113.

After the load phase, the user, through the use of the graphical user interface, invokes (STEP 230) the new software release 118. Generally, during the invoke phase, the master shelf processor card 88 executes the new software release 118 stored in the redundant memory element 113 and distributes the new software release 118 to the other cards 92, 96 of the network element 78. During the invoke stage, the cards of the network element 78 have a copy of the new software release 118 transferred to the redundant memory element 137 and a copy of the current software version 124 stored in the primary memory element 136.

After the invoke stage is complete, the user issues a command, through the graphical user interface, to commit (STEP 240) to the new software release 118. The commit phase copies the new software release 118 into the primary memory elements 112 of the master shelf processor card 88 and the primary memory element 136 of each of the other cards 92, 96 of the network element 78. This action overwrites the current software version 124 with the new software release 118.

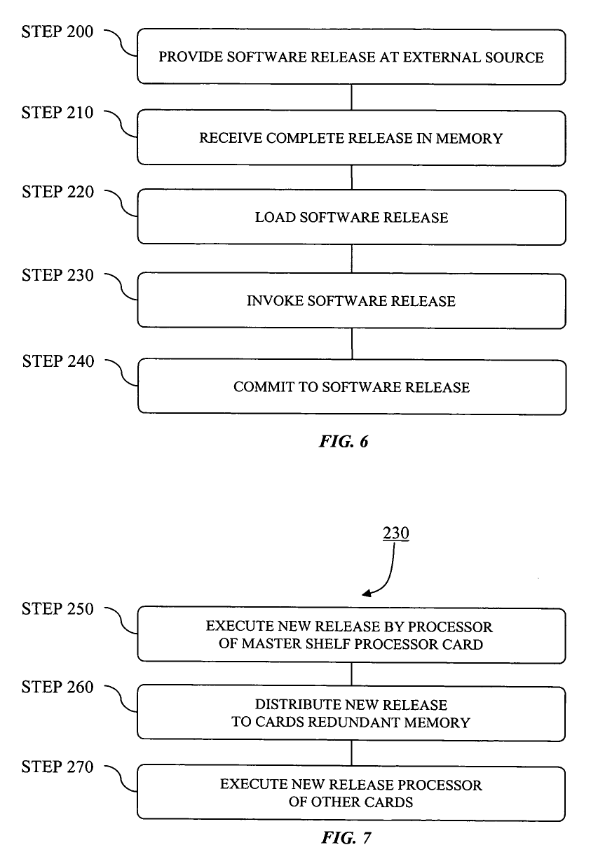

FIG. 7 shows further details of an embodiment of the invoke phase (STEP 230) of FIG. 6. The invoke phase occurs in two stages. The user deliberately activates each invoke stage by activating an invoke button that is part of the graphical user interface. Upon activation of the first invoke stage, the master shelf processor card 88 executes (STEP 250) the new software release 118 stored in the redundant memory element 113. The master shelf processor card 88 then distributes (STEP 260) the new software release 118 from the file system 114 of the network element 78 to the other cards 92, 96 of the network element 78 as appropriate. Each of the other cards 92, 96 receives the new software release 118 and stores the new software release 118 in the redundant memory element 137. After the new software release 188 is distributed to the other cards 92, 96, the other cards 92, 96 are in an intermediate state. That is, each of the cards 92, 96 of the network element 78, except for the master shelf processor card 88, are running the current software version 124, while the master shelf processor card 88 is running the new software release 118. Despite this difference, the master shelf processor card 88 and other cards 92,96 can communicate, raise alarms, and handle conditions, because the present software release 118 is compatible with the current software version 124.

Upon activation of the second invoke stage by the user, the master shelf processor card 88 communicates with each of the other cards 92, 96, and the other cards 92, 96, in response, start to execute (STEP 270) the new software release 118 that is stored in the redundant memory element 137. At this point, each of the other cards 92, 96 of the network element 78 is executing the new software release 118; however, the previous software version 124 is still present in the primary memory elements 136 of the other cards 92,96. Keeping the current software version 124 allows the user to “test” the new software release 118 to ensure proper operation of the network element 78 prior to committing to the new software release 118. The user can still revert back to the current software version 124 if the user is unsatisfied with the operational characteristics of the network element 78 when the network element 78 executes the new software release 118.

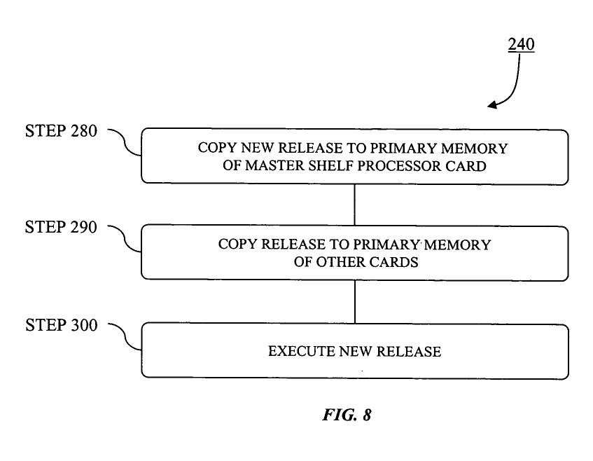

FIG. 8 depicts further details of an embodiment of the commit phase (STEP 240) of FIG. 6. After the user is satisfied with the operational characteristics of the network element 78 while executing the new software release 118, the user activates the commit phase (STEP 240) by pressing the “commit” button on the graphical user interface. In response, the master shelf processor card 88 copies (STEP 280) the contents of the redundant memory element 113 into the primary memory element 112. Consequently, the new software release 118 over-writes the current software version 124 stored in the primary memory element 112. In one embodiment, each of the other cards 92, 96 of the network element 78 copies (STEP 290) the contents of the redundant memory element 137 into the primary memory element 136 sequentially (i.e., one card at a time replaces the current software version 124 with the new software release 118). In another embodiment, the other cards 92, 96 copy the contents of the redundant memory element 137 into the primary memory element 136 (STEP 290) simultaneously. After each card in the network element 78 has two copies of the new software release 118, the network element 78 switches to executing (STEP 300) the new software release 118 from the primary memory elements 112, 136.

Sequential copying allows for in-service upgrades of the network element (i.e., while the network element is carrying traffic). In general, the software upgrade can occur without the loss of traffic, because not all of cards 88, 92, 96 are down at the same time. In another embodiment, a hardware upgrade is performed with the software upgrade while the network element 78 is carrying traffic. In this embodiment, some traffic can be lost. A hardware upgrade, as used herein, means a reprogramming of programmable hardware components to modify the logic functions performed by those components. Examples of such components in the network element 78 include a field-programmable gate array (FPGA) (not shown) and a complex programmable logic device (CPLD) (not shown). When the user activates the second invoke stage (described above), the master shelf processor card 88 coordinates the hardware upgrades to the cards such that upgrades occur sequentially. In some cases, the network element 78 performs protection switching to back up the card that is momentarily unavailable because of the hardware upgrade, thus enabling the traffic to continue to pass through the network element 78. In this instance, the impact on traffic is limited to the time needed to perform the protection switch.

The method of upgrading the current software version of the redundant shelf processor card 88′ is similar to that for upgrading the other cards 92, 96 of the network element 78, in that the redundant shelf processor card 88′ receives the new software release 118 from the master shelf processor card 88. The redundant shelf processor card 88′ also receives the provisioning information for the network element 78 and any files needed to support the upgrade of various types of cards not currently into the network element 78 from the master shelf processor card 88. Then, in the event the redundant shelf processor card 88′ is instructed to operate as a master shelf processor card, the redundant shelf processor card 88′ has the provisioning information for the network element 78 and can also forward the new software release 118 to any type of card that is later installed.

The invention may be implemented as one or more computer-readable software programs embodied on or in one or more articles of manufacture. The article of manufacture can be, for example, any one or combination of a floppy disk, a hard disk, hard-disk drive, a CD-ROM, a DVD-ROM, a flash memory card, an EEPROM, an EPROM, a PROM, a RAM, a ROM, or a magnetic tape. In general, any standard or proprietary, programming or interpretive language can be used to produce the computer-readable software programs. Examples of such languages include C, C++, Pascal, JAVA, BASIC, Visual Basic, and Visual C++. The software programs may be stored on or in one or more articles of manufacture as source code, object code, interpretive code, or executable code.

While the invention has been shown and described with reference to specific preferred embodiments, it should be understood by those skilled in the art that various changes in form and detail may be made therein without departing from the spirit and scope of the invention as defined by the following claims.

1. A method of installing software on a network element of an optical communications system having a plurality of communications cards and a file system, comprising:
providing at a source external to the network element a software release for delivery to the file system of the network element, the software release comprising a plurality of files for providing operational characteristics of the communications cards of the network element; and
receiving from the source external to the network element the complete software release before beginning installation of the software release on the network element.

2. The method of claim 1 further comprising loading the complete software release into a first memory element of a processor card of the network element and invoking the software release to begin installing the complete software release on the network element.

3. The method of claim 2 further comprising committing to the software release to complete the software upgrade.

4. The method of claim 2 wherein invoking comprises executing a file of the complete software release by a processor card of the network element and distributing at least a portion of the complete software release to a second card of the network element.

5. The method of claim 4 wherein distributing comprises copying the at least a portion of the complete software release from the file system of the network element to a first memory element of the second card.

6. The method of claim 4 wherein invoking further comprises replacing a present software release stored in the first memory element of the second card with the at least a portion of the complete software release.

7. The method of claim 6 wherein invoking further comprises executing a file of the at least a portion of the complete software release by the second card.

8. The method of claim 4 wherein committing comprises: copying the complete software release from the first memory location of the processor card to a second memory location of the processor card, thereby creating a redundant copy of the complete software release on the processor card; and
copying the at least a portion of the complete software release from the first memory location of the second card to a second memory location of the second card, thereby creating a redundant copy of the at least a portion of the complete software release on the second card.

9. A method of installing a software release on a network element of an optical communications system, comprising:
storing a complete software release received from a source external to the network element in a redundant memory element of a processor card of the network element before beginning installation of the software release on the network element;
in response to instructions to install the complete software release, executing the complete software release by a processor of the processor card;
replacing a previously stored software release resident in the redundant memory element of a second card of the network element with a copy of at least a portion the complete software release;
instructing the second card to execute the at least a portion of the complete software release from the redundant memory element of the second card;
in response to a commit instruction, copying the at least a portion of the complete software release from the redundant memory element of the second card to a primary memory element of the second card; and
in response to the commit instruction, copying the complete software release from the redundant memory element of the processor card to a primary memory element of the processor card.

10. The method of claim 9 further comprising instructing the processor card to execute the complete software release and the second card to execute the at least a portion of the complete software release to complete the upgrade of the software release executing on the network element.

11. A computer readable medium having instructions thereon for installing software on a network element of an optical communications system having a plurality of communications cards and a file system, the instructions to cause the network element to:
communicate with a source external to the network element, the source providing a software release for delivery to the file system of the network element, the software release comprising a plurality of files for providing operational characteristics of the communications cards of the network element; and
receive from the source external to the network element the complete software release before beginning installation of the software release on the network element.

12. The computer readable medium of claim 11 further comprising instruction to load the complete software release into a first memory element of a processor card of the network element and invoke the software release to begin installing the complete software release on the network element.

13. The computer readable medium of claim 12 further comprising instructions to commit to the software release to complete the software upgrade.

14. The computer readable medium of claim 12 wherein the invoke instructions comprise instructions to execute a file of the complete software release by a processor card of the network element and distribute at least a portion of the complete software release to a second card of the network element.

15. The computer readable medium of claim 14 wherein the distribute instructions comprise instructions to copy the at least a portion of the complete software release from the file system of the network element to a first memory element of the second card.

16. The computer readable medium of claim 14 wherein the invoke instructions further comprise instructions to replace a present software release stored in the first memory element of the second card with the at least a portion of the complete software release.

17. The method of claim 16 wherein the invoke instructions further comprise instructions to execute a file of the at least a portion of the complete software release by the second card.

18. The method of claim 14 wherein the instructions to commit comprise instructions to:
copy the complete software release from the first memory location of the processor card to a second memory location of the processor card, thereby creating a redundant copy of the complete software release on the processor card; and
copy the at least a portion of the complete software release from the first memory location of the second card to a second memory location of the second card, thereby creating a redundant copy of the at least a portion of the complete software release on the second card.
